(19) United States
(12) Patent Application Publication
(10) Pub. No.: US 2026/0274349 A1
(43) Pub. Date: Sep. 17, 2026

(54) VEHICLE BODY STRUCTURE

(71) Applicant: Honda Motor Co., Ltd., Tokyo (JP)

(72) Inventors: Kota FUJISAWA, Tokyo (JP); Ichiro KAWAHARA, Tokyo (JP)

(73) Assignee: Honda Motor Co., Ltd., Tokyo (JP)

(21) Appl. No.: 19/433,107

(22) Filed: Dec. 26, 2025

(30) Foreign Application Priority Data
Mar. 11, 2025 (CN) 202510282647.6

(51) Int. Cl. B62D 25/20

(52) U.S. Cl. CPC B62D 25/20

(57) ABSTRACT

The disclosure provides a vehicle body structure capable of achieving good load transmission performance. The vehicle body structure has a compartment formed therein and includes: a floor panel; a floor channel protruding upward from a center of the floor panel in a vehicle width direction; a front beam connected to the floor channel and extending in the vehicle width direction; and a reinforcing component disposed on a lower side of the floor channel and extending in the vehicle longitudinal direction, having a side wall part, a horizontal part, and a connecting part, wherein the side wall part faces and abuts against a side wall of the floor channel, the horizontal part faces and abuts against the floor panel, and the reinforcing component includes: a front reinforcing component disposed in front of the front beam; and a rear reinforcing component disposed behind the front beam, and the connecting part of the reinforcing component is a part where the front reinforcing component and the rear reinforcing component connect to each other, and the connecting part of the reinforcing component is disposed at a position that overlaps with a cross-section of the front beam in the vehicle longitudinal direction.

### CROSS-REFERENCE TO RELATED APPLICATION

This application claims the priority benefit of China application serial no. 202510282647.6, filed on March, 11, 2025. The entirety of the above-mentioned patent application is hereby incorporated by reference herein and made a part of this specification.

### BACKGROUND

### Technical Field

The disclosure relates to a vehicle body structure.

### Description of Related Art

In recent years, efforts to provide access to sustainable transportation systems that also consider vulnerable people among traffic participants, such as the elderly, disabled, or children, are becoming active. To achieve this purpose, research and development are being conducted to further improve traffic safety and convenience through development related to collision safety performance.

Patent Literature 1 (Japanese Patent Publication No. 4853080) discloses a channel structure set on a floor panel of a vehicle body, the channel structure including a channel side frame and a channel reinforcing component, wherein the channel side frame and the channel reinforcing component form a closed cross-section in the vicinity of the channel part for transmitting and dispersing loads during collision. However, since the channel structure of patent Literature 1 strengthens by forming a closed cross-section using a channel reinforcing component protruding from the channel part toward the vehicle interior, the larger the formed closed cross-section, the greater the sense of oppression on the interior space, resulting in a contradiction between the collision safety performance of the channel structure and the spaciousness of the interior space. Therefore, how to effectively transmit loads during collision without affecting the spaciousness of the interior space is a problem yet to be solved.

The disclosure aims to solve the aforementioned problem to achieve improved collision safety performance. Moreover, it further contributes to the development of sustainable transportation systems.

### SUMMARY

The disclosure provides a vehicle body structure capable of achieving good load transmission performance.

According to an embodiment of the disclosure, a vehicle body structure has a compartment formed in the vehicle body structure, and includes: a floor panel; a floor channel protruding upward from a center of the floor panel in a vehicle width direction; a front beam connected to the floor channel and extending in the vehicle width direction; and a reinforcing component disposed on a lower side of the floor channel and extending in the vehicle longitudinal direction, having a side wall part, a horizontal part, and a connecting part, wherein the side wall part faces and abuts against a side wall of the floor channel, and the horizontal part faces and abuts against the floor panel. The reinforcing component includes: a front reinforcing component disposed in front of the front beam; and a rear reinforcing component disposed behind the front beam, and the connecting part of the reinforcing component is a part where the front reinforcing component and the rear reinforcing component connect to each other, and is disposed at a position that overlaps with a cross-section of the front beam in the vehicle longitudinal direction.

In an embodiment of the disclosure, the vehicle body structure further includes a connecting component connecting a pair of the connecting parts on left and right sides in th e reinforcing component on the lower side of the floor channel.

In an embodiment of the disclosure, the connecting component abuts against a lower surface of the floor channel.

In an embodiment of the disclosure, the front beam connects to the connecting component through a side wall of the floor channel.

In an embodiment of the disclosure, the vehicle body structure further includes: a rear beam located behind the front beam and located in front of a foot area of an occupant on a second-row seat behind a driver, and the rear reinforcing component extends to a rear end of the rear beam.

In an embodiment of the disclosure, a front mounting point of a first-row seat on which the driver sits is disposed on the front beam, and a rear mounting point of the first-row se at is disposed on the rear beam.

In an embodiment of the disclosure, the vehicle body structure further includes: a dashboard lower panel disposed on a front-end side of the vehicle body structure, and the floor panel and the dashboard lower panel separate an interior region and an exterior region of the compartment; a side frame extending in the vehicle longitudinal direction in a front compartment located in the exterior region; a front frame disposed in relative to a rear region of the side frame with the dashboard lower panel therebetween in the interior region, and extending in the vehicle longitudinal direction along the dashboard lower panel; an inner beam extending inward in the vehicle width direction from the front frame, and the front reinforcing component connects to the inner beam.

In an embodiment of the disclosure, yield strength of the front reinforcing component exceeds yield strength of the rear reinforcing component.

Based on the above, in the embodiment of the disclosure, the vehicle body structure through the configuration of the reinforcing component disposed on the lower side of the floor channel may form a structure that does not compress the space of the interior region. Moreover, through the configuration where the side wall part of the reinforcing component faces and abuts against the side wall of the floor channel, and the horizontal part faces and abuts against the floor panel, the reinforcing component is formed as an L-shaped structure extending in the vehicle longitudinal direction. Thus, when collision load from the front of the vehicle transmits to the floor channel, the collision load may transmit at the part where the side wall part and the horizontal part of the reinforcing component intersect (i.e., the ridge line part extending in the vehicle longitudinal direction). Furthermore, since the connecting part where the front reinforcing component and the rear reinforcing component in the reinforcing component connect to each other is disposed in the region strengthened by the cross-section of the front beam, deformation of the front reinforcing component and the rear reinforcing component from the connecting part may be suppressed.

To make the above features and advantages of the disclosure more obvious and understandable, embodiments are specifically provided below and described in detail in conjunction with the accompanying drawings as follows.

### BRIEF DESCRIPTION OF THE DRAWINGS

FIG. 1 is a schematic diagram of a vehicle body structure according to an embodiment of the disclosure.

FIG. 2 is a schematic diagram of the vehicle body structure shown in FIG. 1 when viewed from below.

FIG. 3 is a schematic diagram when viewed from another angle according to an embodiment of the disclosure.

FIG. 4A is a cross-sectional schematic diagram of the vehicle body structure shown in FIG. 1 along line A-A.

FIG. 4B is a cross-sectional schematic diagram of a vehicle body structure according to another embodiment of the disclosure.

FIG. 5 is a top view schematic diagram of the vehicle body structure shown in FIG. 1 with a seat front mounting bracket installed.

### DESCRIPTION OF THE EMBODIMENTS

Reference will now be made in detail to exemplary embodiments of the disclosure; examples of the exemplary embodiments are illustrated in the accompanying drawings. Wherever possible, the same reference numerals will be used throughout the drawings and the description to refer to the same or like parts.

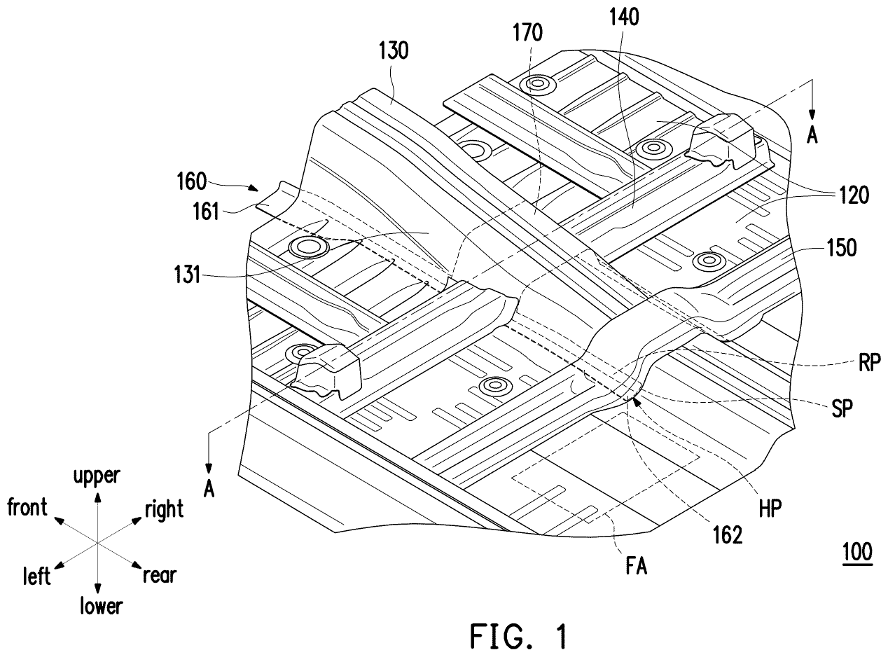

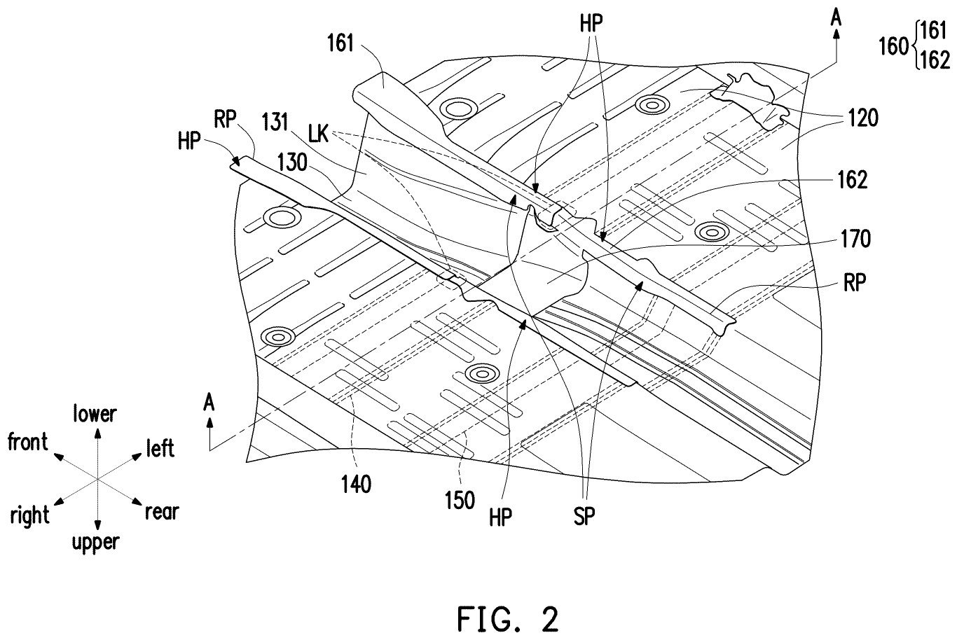

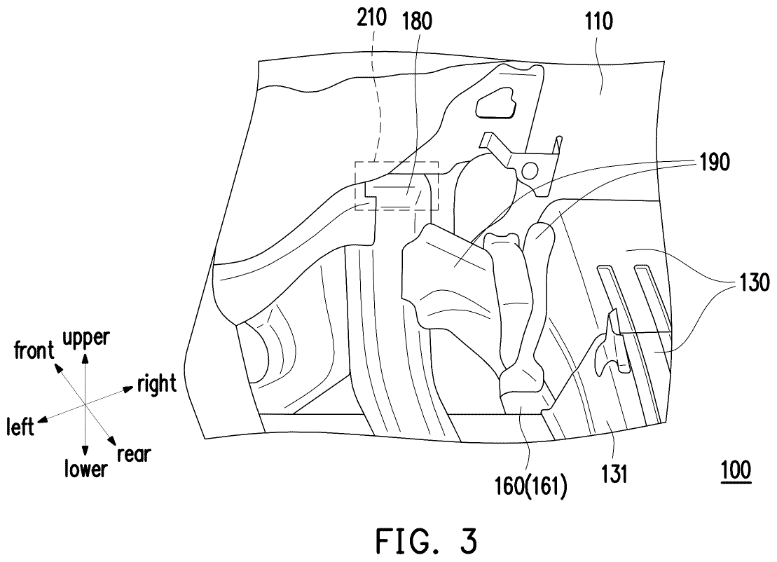

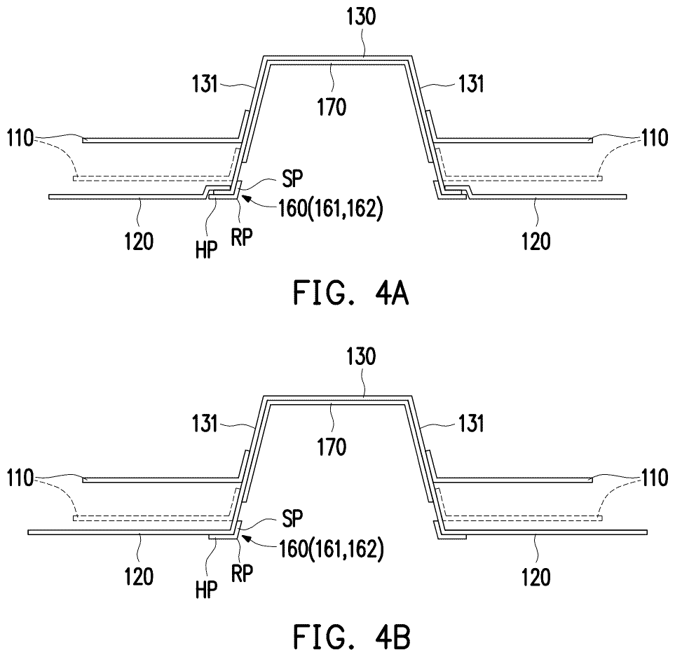

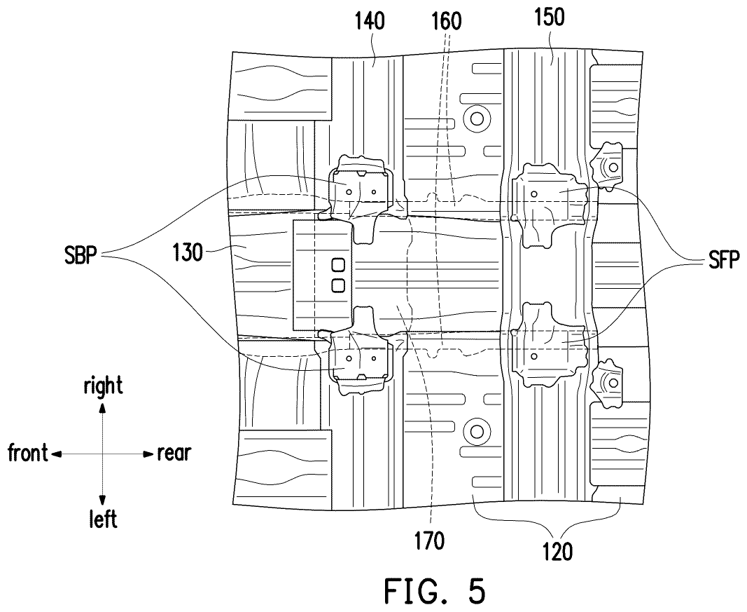

FIG. 1 is a schematic diagram of a vehicle body structure according to an embodiment of the disclosure; FIG. 2 is a schematic diagram of the vehicle body structure shown in FIG. 1 when viewed from below; FIG. 3 is a schematic diagram when viewed from another angle according to an embodiment of the disclosure; FIG. 4A is a cross-sectional schematic diagram of the vehicle body structure shown in FIG. 1 along line A-A; FIG. 4B is a cross-sectional schematic diagram of a vehicle body structure according to another embodiment of the disclosure; FIG. 5 is a top view schematic diagram of the vehicle body structure shown in FIG. 1 with a seat front mounting bracket installed. In this embodiment, a vehicle body structure 100 refers to the vehicle body structure 100 in a front range of rear seat occupants located behind the driver in the vehicle, that is, the rear beam 150 in the vehicle body structure 100 here is not a beam component (such as: intermediate beam, etc.) installed on a rear floor panel at the rear of the vehicle, but is a beam component located in front of a foot area FA of the rear seat occupants. It should be noted that, for convenience hereinafter, the front-rear direction, left-right direction, and upper-lower direction of the vehicle are defined as shown in the figures, the configuration of each part is illustrated according to this definition, and the front-rear direction, left-right direction, and upper-lower direction of the vehicle correspond to the vehicle longitudinal direction, vehicle width direction, and vehicle height direction, respectively.

Referring to FIG. 1 to FIG. 3, in this embodiment, the vehicle body structure 100 includes a dashboard lower panel 110, a floor panel 120, a floor channel 130, a front beam 140, a rear beam 150, a reinforcing component 160, a connecting component 170, a side frame 210, a front frame 180, and an inner beam 190. As shown in FIG. 1 to FIG. 3, in this embodiment, the dashboard lower panel 110 is disposed at a front-end side of the vehicle body structure 100, and the floor panel 120 and the dashboard lower panel 110 separate an interior region and an exterior region of a compartment of the vehicle body structure 100, wherein the interior region in the compartment is an interior space of the vehicle where occupants are seated. Furthermore, as shown in FIG. 1 and FIG. 2, in this embodiment, the floor channel 130 protrudes upward from a center of the floor panel 120 in a vehicle width direction. The rear beam 150 is located behind the front beam 140, and the front beam 140 and the rear beam 150 connect to the floor channel 130 and extend in the vehicle width direction. The reinforcing component 160 is disposed on a lower side of the floor channel 130 to face the exterior region, and extends in the vehicle longitudinal direction.

Specifically, as shown in FIG. 1, FIG. 2, and FIG. 4A, in this embodiment, the reinforcing component 160 has a side wall part SP, a horizontal part HP, and a connecting part LK. The side wall part SP faces and abuts against a side wall 131 of the floor channel 130, and the horizontal part HP faces and abuts against the floor panel 120. Thus, the vehicle body structure 100, through the configuration of the reinforcing component 160 disposed on the lower side of the floor channel 130, may form a structure that does not compress the space of the interior region. Moreover, as shown in FIG. 1, FIG. 2, and FIG. 4A, in this embodiment, through the configuration where the side wall part SP of the reinforcing component 160 faces and abuts against the side wall 131 of the floor channel 130, and the horizontal part HP faces and abuts against the floor panel 120, the reinforcing component 160 is formed as an L-shaped structure extending in the vehicle longitudinal direction. Thus, when a collision load from the front of the vehicle is transmitted to the floor channel 130, the collision load may be transmitted at a part where the side wall part SP and the horizontal part HP of the reinforcing component 160 intersect (i.e., a ridge line part RP extending in the vehicle longitudinal direction). Furthermore, in this embodiment, although the floor channel 130 and the floor panel 120 are illustrated as independent components respectively, the disclosure is not limited thereto. In another embodiment as shown in FIG. 4B, the floor channel 130 and the floor panel 120 may also be an integral component formed integrally, and may also form a structure having similar functions.

Furthermore, as shown in FIG. 2, in this embodiment, the reinforcing component 160 includes a front reinforcing component 161 and a rear reinforcing component 162. The front reinforcing component 161 is disposed in front of the front beam 140, the rear reinforcing component 162 is disposed behind the front beam 140, and the connecting part LK of the reinforcing component 160 is a part where the front reinforcing component 161 and the rear reinforcing component 162 connect to each other, and is disposed at a position that has a cross-sectional overlap with the front beam 140 in the vehicle longitudinal direction. Thus, since the connecting part LK where the front reinforcing component 161 and the rear reinforcing component 162 in the reinforcing component 160 connect to each other is disposed in a region strengthened by the cross-section of the front beam 140, deformation of the front reinforcing component 161 and the rear reinforcing component 162 from the connecting part LK when transmitting collision load may be suppressed.

Moreover, as shown in FIG. 2, in this embodiment, the connecting component 170 connects a pair of connecting parts LK on the left and right sides in the reinforcing component 160 on the lower side of the floor channel 130. Thus, by setting the connecting component 170 that connects the pair of connecting parts LK on the left and right sides, deformation of the front reinforcing component 161 and the rear reinforcing component 162 at the connecting part LK when transmitting collision load may also be prevented. Furthermore, as shown in FIG. 2, in this embodiment, the connecting component 170 abuts against the lower surface of the floor channel 130. Thus, since the connecting component 170 contacts the lower surface of the floor channel 130, i.e., is firmly attached to the lower side of the floor channel 130 toward the exterior region, the setting of the connecting component 170 does not compress the internal space of the floor channel 130.

Furthermore, as shown in FIG. 2 and FIG. 4A, in this embodiment, the front beam 140 connects to the connecting component 170 via the side wall 131 of the floor channel 130. Thus, since the front beam 140 connects to the connecting component 170 via the side wall 131 of the floor channel 130, when collision load from the side of the vehicle transmits to the front beam 140, the load may also transmit via the connecting component 170, forming a load transmission path in the vehicle width direction, thereby improving the load transmission performance when the vehicle occurs side collision. Furthermore, as shown in FIG. 1 and FIG. 2, the rear beam 150 is located in front of the foot area FA of the rear seat occupant on the second-row seat behind the driver, and the rear reinforcing component 162 extends to the rear end of the rear beam 150. Thus, in this embodiment, the rear end of the rear reinforcing component 162 may be strengthened through the cross-section of the rear beam 150, and its load transmission performance may also be ensured.

On the other hand, as shown in FIG. 3, in this embodiment, the side frame 210 extends in the vehicle longitudinal direction in the front compartment located in the exterior region. The front frame 180 is disposed in relative to the rear region of the side frame 210 with the dashboard lower panel 110 therebetween in the interior region, and extends in the vehicle longitudinal direction along the dashboard lower panel 110. The inner beam 190 extends inward in the vehicle width direction from the front frame 180, and the front reinforcing component 161 connects to the inner beam 190. Thus, when collision load from the front of the vehicle transmits to the floor channel 130, the collision load may efficiently transmit from the inner beam 190 to the front reinforcing component 161.

Furthermore, in this embodiment, the yield strength of the front reinforcing component 161 exceeds that of the rear reinforcing component 162, where yield strength refers to the maximum stress that a material may generate without causing plastic deformation. Thus, when the vehicle occurs collision involving the entire front part of the vehicle body structure 100 (for example, full wrap collision), the collision load disperses and transmits to the pair of front reinforcing components 161 on the left and right sides, and disperses and transmits to both sides in the vehicle width direction through the front beam 140, enabling the load transmission path to terminate at the front beam 140 at the front part of the floor channel 130. On the other hand, when offset collision occurs, the collision load biases toward one of the front reinforcing components 161 respectively located on the left and right sides, at which time the collision load transmits from the front reinforcing component 161 to the rear reinforcing component 162 via the connecting part LK to disperse the load. That is, regardless of whether the collision from the front of the vehicle is full wrap collision or offset collision, the front reinforcing component 161 is located on the load transmission path and requires high yield strength, relative to this, the rear reinforcing component 162 only requires yield strength sufficient to transmit load in offset collision to obtain sufficient load transmission performance. Therefore, setting the yield strength of the front reinforcing component 161 to exceed that of the rear reinforcing component 162 may locally strengthen the region on the load transmission path, and may save product cost.

Furthermore, as shown in FIG. 5, in this embodiment, the installation point of the seat front mounting bracket SFP of the first-row seat where the driver sits is disposed on the front beam 140, and the installation point of the seat rear mounting bracket SBP of the seat mounting bracket of the first-row seat is disposed on the rear beam 150. Thus, due to the configuration of the reinforcing component 160, the vehicle body structure 100 may maintain the distance between the front beam 140 and the rear beam 150 in the vehicle longitudinal direction through the reinforcing component 160, therefore the installation performance of the seat is also improved thereby.

In summary, in the embodiment of the disclosure, the vehicle body structure through the configuration of the reinforcing component disposed on the lower side of the floor channel may form a structure that does not compress the space of the interior region. Moreover, through the configuration where the side wall part of the reinforcing component faces and abuts against the side wall of the floor channel, and the horizontal part faces and abuts against the floor panel, the reinforcing component is formed as an L-shaped structure extending in the vehicle longitudinal direction. Thus, when collision load from the front of the vehicle transmits to the floor channel, the collision load may transmit at the part where the side wall part and the horizontal part of the reinforcing component intersect (i.e., the ridge line part extending in the vehicle longitudinal direction). Furthermore, since the connecting part where the front reinforcing component and the rear reinforcing component in the reinforcing component connect to each other is disposed in the region strengthened by the cross-section of the front beam, deformation of the front reinforcing component and the rear reinforcing component from the connecting part when transmitting collision load may be suppressed.

Finally, it should be illustrated that: the embodiments are only used to illustrate the technical solution of the disclosure, rather than limiting it; although the disclosure has been illustrated in detail with reference to the embodiments, ordinary technical personnel in the field should understand that: they may still modify the technical solutions recorded in the embodiments, or perform equivalent substitution on part or all of the technical features therein; and these modifications or substitutions do not make the essence of the corresponding technical solutions depart from the scope of the technical solutions of the embodiments of the disclosure.

What is claimed is:

1. A vehicle body structure, wherein a compartment is formed in the vehicle body structure, and the vehicle body structure comprises:
a floor panel;
a floor channel, protruding upward from a center of the floor panel in a vehicle width direction;
a front beam, connected to the floor channel and extending in the vehicle width direction; and
a reinforcing component, disposed on a lower side of the floor channel and extending a vehicle longitudinal direction, having a side wall part, a horizontal part, and a connecting part, wherein the side wall part faces and abuts against a side wall of the floor channel, the horizontal part faces and abuts against the floor panel, and the reinforcing component comprises:
a front reinforcing component, disposed in front of the front beam; and
a rear reinforcing component, disposed behind the front beam, and
the connecting part of the reinforcing component is a part where the front reinforcing component and the rear reinforcing component connect to each other, and is disposed at a position that overlap with a cross-sectional of the front beam in the vehicle longitudinal direction.

2. The vehicle body structure according to claim 1, further comprising:
a connecting component, connecting a pair of the connecting parts on left and right sides in the reinforcing component on the lower side of the floor channel.

3. The vehicle body structure according to claim 2, wherein the connecting component abuts against a lower surface of the floor channel.

4. The vehicle body structure according to claim 3, wherein the front beam connects to the connecting component through the side wall of the floor channel.

5. The vehicle body structure according to claim 1, further comprising:
a rear beam, located behind the front beam and located in front of a foot area of an occupant on a second-row seat behind a driver, and the rear reinforcing component extends to a rear end of the rear beam.

6. The vehicle body structure according to claim 5, wherein a front mounting point of a first-row seat on which the driver sits is disposed on the front beam; and a rear mounting point of the first-row seat is disposed on the rear beam.

7. The vehicle body structure according to claim 1, further comprising:
a dashboard lower panel, disposed on a front-end side of the vehicle body structure, and the floor panel and the dashboard lower panel separate an interior region and an exterior region of the compartment;
a side frame, extending in the vehicle longitudinal direction in a front compartment located in the exterior region;
a front frame, disposed in relative to a rear region of the side frame with the dashboard lower panel therebetween in the interior region, and extending in the vehicle longitudinal direction along the dashboard lower panel;
an inner beam, extending inward in the vehicle width direction from the front frame, and the front reinforcing component connects to the inner beam.

8. The vehicle body structure according to claim 1, wherein yield strength of the front reinforcing component exceeds yield strength of the rear reinforcing component.
